(19) United States
(12) Patent Application Publication
(10) Pub. No.: US 2010/0235443 A1
(43) Pub. Date: Sep. 16, 2010

(54) METHOD AND APPARATUS OF PROVIDING A LOCKET SERVICE FOR CONTENT SHARING

(76) Inventors: Tero Antero Laiho, Helsinki (FI); Ari Tapani Koli, Helsinki (FI); Jukka Kalervo Immonen, Espoo (FI); Jari Pekka Sukanen, Espoo (FI); Tatu Antero Tahkokallio, Espoo (FI); Matti Keltanen, Helsinki (FI); Charlie Gower, London (GB)

Correspondence Address: DITTHAVONG MORI & STEINER, P.C., 918 Prince Street, Alexandria, VA, 22314, US

(21) Appl. No.: 12/401,379

(22) Filed: Mar. 10, 2009

(51) Int. Cl. G06F 15/16

(52) U.S. Cl. 709/204

(57) ABSTRACT

An approach is provided for sharing rendered content that includes receiving a request for a content locket for a user. The content locket includes data indicating a content playlist associated with the user, and script for generating a message that requests an action related to the content indicated in the content playlist. The content locket is forwarded. In response to receiving the message generated by the script, the action related to the content is performed. The content locket can be embedded in a web page or passed in other messages, such as emails or instant messenger messages.

### BACKGROUND

Content sharing applications have been one of the most widely used and popular applications over the Internet. At the same time, the use of wireless communication devices has become pervasive, and is rapidly overtaking the use of traditional wired devices. For example, one popular area involves the sharing of audio files and the generation and sharing of playlists. Traditionally, the creation and sharing of such playlists has unnecessarily consumed network resources. Because network resources, particularly in bandwidth-constrained systems such as wireless networks, are scarce, and user devices are becoming more compact with less space for new applications, designing a proper mechanism for implementing such content sharing is vital.

### SOME EXAMPLE EMBODIMENTS

Therefore, there is a need for easily identifying the playlists of friends or favorite persons in a manner that does not demand new applications on a user's device. In various embodiments, a content locket that can be opened to render the content in a playlist of another user is passed in a web page or email or a message of some other existing application process. As used herein, a locket is a software object that can be embedded in a web page or email or other message for presentation to one or more users. Software objects are self-contained collections of data and methods and used, for example, in object-oriented programming (OOP). In some embodiments, a locket provides a graphical user interface (GUI).

According to one embodiment, a computer-readable storage medium carries instructions which, when executed by a processor, cause the one or more processors to at least perform receiving a request for a content locket for a user. The content locket includes data indicating a content playlist associated with the user, and script for generating a message that requests an action related to rendering content indicated in the content playlist. Forwarding of the content locket is initiated. In response to receiving the message generated by the script, the action related to rendering the content is performed.

According to another embodiment, an apparatus comprises a processor and a memory storing executable instructions that if executed cause the apparatus to receive a request for a content locket for a user. The processor and memory are also configured to initiate forwarding of the content locket. In response to receiving the message generated by the script, the processor and memory are also configured to cause the action related to rendering the content to be performed.

According to another embodiment, a method includes providing access for requesting a content locket for a user. The content locket includes data indicating a content playlist associated with the user, and script for generating a message that requests an action related to rendering content indicated in the content playlist. The content locket is received. In response to sending the message generated by the script, the action related to rendering the content is performed.

According to another embodiment, an apparatus comprises a processor and a memory storing executable instructions that if executed cause the apparatus to receive a first locket object to indicate content associated with a first user. In response to receiving the first locket object, the processor and memory are also configured to embed the first locket object in a requested web page before initiating returning the requested web page to a web browser process for the first user.

Still other aspects, features, and advantages of the invention are readily apparent from the following detailed description, simply by illustrating a number of particular embodiments and implementations, including the best mode contemplated for carrying out the invention. The invention is also capable of other and different embodiments, and its several details can be modified in various obvious respects, all without departing from the spirit and scope of the invention. Accordingly, the drawings and description are to be regarded as illustrative in nature, and not as restrictive.

### BRIEF DESCRIPTION OF THE DRAWINGS

The embodiments of the invention are illustrated by way of example, and not by way of limitation, in the figures of the accompanying drawings:

FIG. 1 is a diagram of a system for sharing played content, according to one embodiment;

FIG. 2 is a diagram of components of a content service module, according to one embodiment;

FIG. 3A is a diagram of a play event message, according to one embodiment;

FIG. 3B is a diagram of a content locket, according to one embodiment;

FIG. 3C is a diagram of an example web page with multiple lockets embedded thereon, according to an embodiment;

FIG. 4 is a flowchart of a process in a web server to use content lockets, according to one embodiment;

FIG. 5 is a flowchart of a process at a content locket or content locket service to provide and render shared content, according to one embodiment;

FIG. 6 is a time sequence diagram that illustrates a sequence of messages and processes for tracking content rendering by a user, according to one embodiment;

FIG. 7A is a time sequence diagram that illustrates a sequence of messages and processes for initializing and embedding a content locket in a web page, according to one embodiment;

FIG. 7B is a time sequence diagram that illustrates a sequence of messages and processes for detailed web page interactions with a locket service, according to one embodiment;

FIG. 7C is a time sequence diagram that illustrates a sequence of messages and processes for reporting locket usage, according to one embodiment;

FIG. 7D is a time sequence diagram that illustrates a sequence of messages and processes for determining current rendering of content, according to one embodiment;

FIG. 8 is a diagram of hardware that can be used to implement an embodiment of the invention;

FIG. 9 is a diagram of a chip set that can be used to implement an embodiment of the invention; and

FIG. 10 is a diagram of a terminal that can be used to implement an embodiment of the invention.

### DETAILED DESCRIPTION OF EXAMPLE EMBODIMENTS

A method, apparatus, and software of providing a locket service for content sharing are disclosed. In the following description, for the purposes of explanation, numerous specific details are set forth in order to provide a thorough understanding of the embodiments of the invention. It is apparent, however, to one skilled in the art that the embodiments of the invention may be practiced without these specific details or with an equivalent arrangement. In other instances, well-known structures and devices are shown in block diagram form in order to avoid unnecessarily obscuring the embodiments of the invention.

Although several embodiments of the invention are discussed with respect to music sharing using a web browser, it is recognized by one of ordinary skill in the art that the embodiments of the inventions have applicability to any type of content rendering, e.g., music or video playback or streaming, games playing, image or map displaying, radio or television content broadcasting or streaming, involving any device, e.g., wired and wireless local device or both local and remote wired or wireless devices, capable of rendering content, or capable of communication with such a device, using any application that allows objects to be embedded, such a standard web browser, a standard email client, a standard instant messaging client, and a standard file transfer protocol (FTP) client. As used herein, content or media includes, for example, digital sound, songs, digital images, digital games, digital maps, point of interest information, digital videos, such as music videos, news clips and theatrical videos, advertisements, program files or objects, any other digital media or content, or any combination thereof. The term rendering indicates any method for presenting the content to a human user, including playing music through speakers, displaying images on a screen or in a projection or on tangible media such as photographic or plain paper, showing videos on a suitable display device with sound, graphing game or map data, or any other term of art for presentation, or any combination thereof. In many illustrated embodiments, a player is an example of a rendering module. A playlist is information about content rendered on one or more players in response to input by a user, and is associated with that user. A play history is information about the time sequence of content rendered on one or more players in response to input by a user, and is associated with that user.

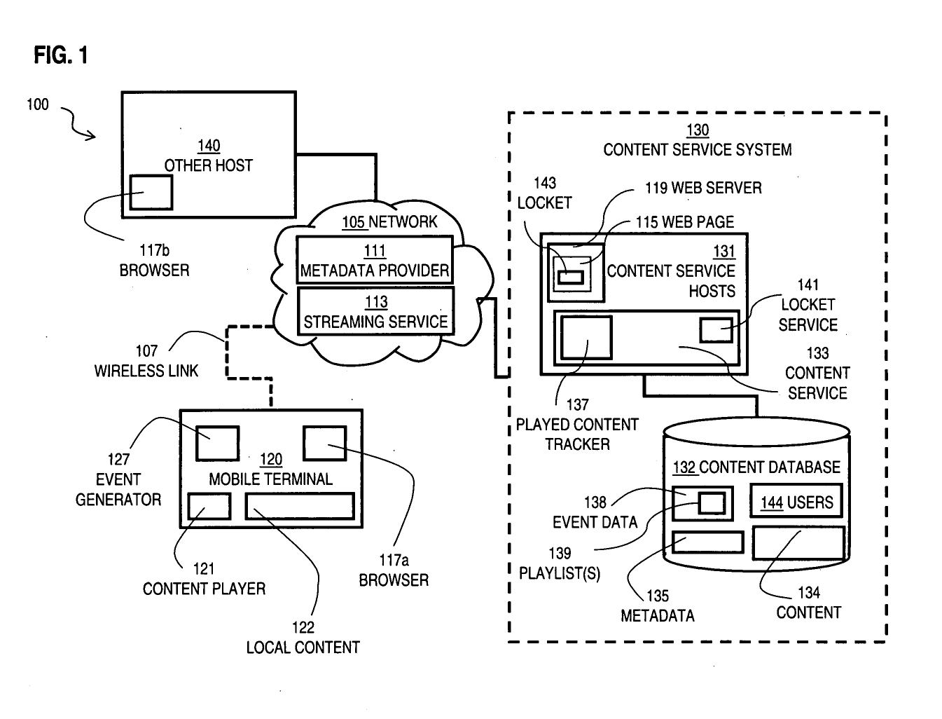

FIG. 1 is a diagram of a system for sharing played content, according to one embodiment. As shown in FIG. 1, a system 100 includes a content service system 130 and a plurality of nodes (e.g., nodes 120, 131, 140) having connection with each other through a communication network 105. The system 100 utilizes a standard web browser to facilitate efficient sharing of playlists and metadata about content in a playlist.

In certain embodiments, metadata can be represented as a collection of one or more values for corresponding parameters that are useful to describe content. Any combination of values for one or more metadata parameters may be used to identify the content. In the illustrated embodiments, the content is identified by the values for the content name and artist name metadata parameters.

An important aspect of content sharing is identifying the content to be downloaded to a local wired or wireless device, and finding a source for that content on the network that is available to the local device. Another important aspect of content sharing is transferring a list of content available or played on one local or remote device to another local or remote device, often using a network available to both. For example, the transfer of such lists enables a user to move music listened to on one device, such as a portable MP3 player, to another device, such as a personal computer, so that the user can select from that list to bum a compact disc (CD) or Digital Versatile Disc (DVD, also called a or Digital Video Disc) with the user's favorite music. Similarly, a user can share a list of favorite content with a friend or acquaintance.

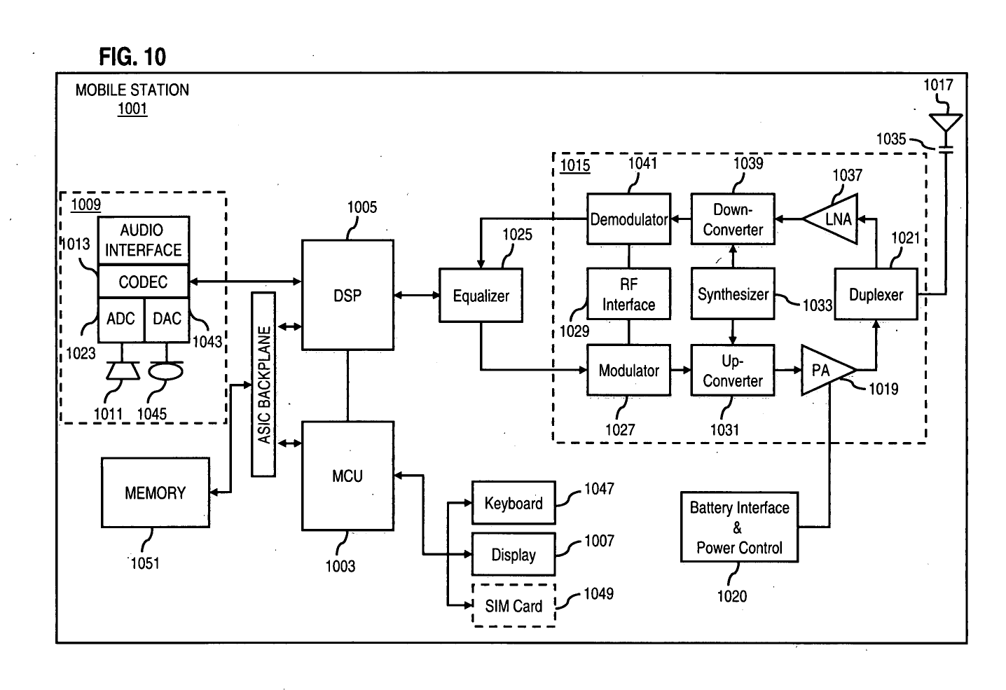

In various embodiments, nodes 120, 131, 140 can be any type of fixed terminal, mobile terminal, or portable terminal including desktop computers, laptop computers, handsets, stations, units, devices, multimedia tablets, Internet nodes, communicators, Personal Digital Assistants (PDAs), mobile phones, mobile communication devices, audio/video players, digital cameras/camcorders, televisions, digital video recorders, game devices, positioning devices, or any combination thereof. Moreover, the nodes may have a hard-wired energy source (e.g., a plug-in power adapter), a limited energy source (e.g., a battery), or both. It is further contemplated that the nodes 120, 131, 140 can support any type of interface to the user (such as “wearable” circuitry, etc.). In the illustrated embodiment, node 120 is a wireless mobile terminal (also called a mobile station and described in more detail below with reference to FIG. 10). The mobile terminal 120 is connected to network 105 by a wireless link 107.

By way of example, the communication network 105 of system 100 can include one or more wired and/or wireless networks such as a data network (not shown), a wireless network (not shown), a telephony network (not shown), or any combination thereof, each comprised of zero or more nodes. It is contemplated that the data network may be any local area network (LAN), metropolitan area network (MAN), wide area network (WAN), the Internet, or any other suitable packet-switched network, such as a commercially owned, proprietary packet-switched network, e.g., a proprietary cable or fiber-optic network, or any combination thereof. In addition, the wireless network may be, for example, a cellular network and may employ various technologies including code division multiple access (CDMA), enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., microwave access (WiMAX), Long Term Evolution (LTE) networks, wireless fidelity (WiFi), satellite, and the like. In various embodiments, communication network 105, or portions thereof, can support communication using any protocol, for example, the Internet Protocol (IP).

Information is exchanged between network nodes of system 100 according to one or more of many protocols (including, e.g., known and standardized protocols). In this context, a protocol includes a set of rules defining how the nodes interact with each other based on information sent over the communication links. The protocols are effective at different layers of operation within each node, from generating and receiving physical signals of various types, to selecting a link for transferring those signals, to the format of information indicated by those signals, to identifying which software application executing on a computer system sends or receives the information. The conceptually different layers of protocols for exchanging information over a network are described in the Open Systems Interconnection (OSI) Reference Model. The OSI Reference Model is generally described in more detail in Section 1.1 of the reference book entitled “Interconnections Second Edition,” by Radia Perlman, published September 1999.

The client-server model of computer process interaction is widely known and used. According to the client-server model, a client process sends a message including a request to a server process, and the server process responds by providing a service. The server process may also return a message with a response to the client process. Often the client process and server process execute on different computer devices, called hosts, and communicate via a network using one or more protocols for network communications. The term “server” is conventionally used to refer to the process that provides the service, or the host computer on which the process operates. Similarly, the term “client” is conventionally used to refer to the process that makes the request, or the host computer on which the process operates. As used herein, the terms “client” and “server” refer to the processes, rather than the host computers, unless otherwise clear from the context. In addition, the process performed by a server can be broken up to run as multiple processes on multiple hosts (sometimes called tiers) for reasons that include reliability, scalability, and redundancy, among others.

As shown in FIG. 1, network 105 includes a content metadata provider process 111 and a content streaming service process 113 operating on one or more nodes of the network 105, both well known in the art. In some embodiments, the network also includes a message service process (not shown), also well known in the art.

The mobile terminal 120 includes a data structure with local content 122, and a content rendering/player process 121 and an event generator process 127. The content rendering/player process 121 is operative to render, such as play, present and/or display, content from the local content data structure 122 in response to input by a user. According to the illustrated embodiment, the mobile terminal includes event generator 127 that sends event messages over the network 105 based on the operation of content player process 121 to indicate what or when content is played, or both, on the mobile terminal 120 by a user of that mobile terminal 120.

The mobile terminal 120 includes a standard web browser 117a, which is a client process that renders web pages received from any of multiple web servers connected through network 105. Messages between web browsers and servers use the hypertext transfer protocol (HTTP). Web browsers are common on most network devices, and typically are able to execute scripts sent by the web server to render content, as is well known in the art. In the illustrated embodiment, other host 140 includes a web browser 117b. Web browsers 117a and 117b are collectively referenced hereinafter as web browsers 117.

The content service system 130 includes one or more content service hosts 131 and a content database 132. The content service hosts are connected directly or indirectly to network 105. The content database 132 resides on one or more nodes connected directly or indirectly to the content service hosts 131, and it is anticipated that, in some embodiments, content database 132 resides on one or more nodes in network 105. The content database 132 includes one or more processes (not shown) and one or more data structures, including one or more content data structures 134 that store content, a metadata data structure 135 that stores information about the content, and a users data structure 144 that stores information about registered users of the content service. In the illustrated embodiment, the content database 132 includes an event data structure 138 that stores information about events associated with rendering content. The event data structure 138 includes playlists data structure 139 that holds data that indicates what content has been played by each of one or more users on one or more nodes of system 100.

The content service hosts 131 are one or more nodes that support a web server 119 and the content service module 133. The content service module 133 is a process that supports users in finding and rendering content on their local devices in communication with the network 105. In the illustrated embodiment, the content service module 133 includes a played content tracker process 137, and a content locket service process 141.

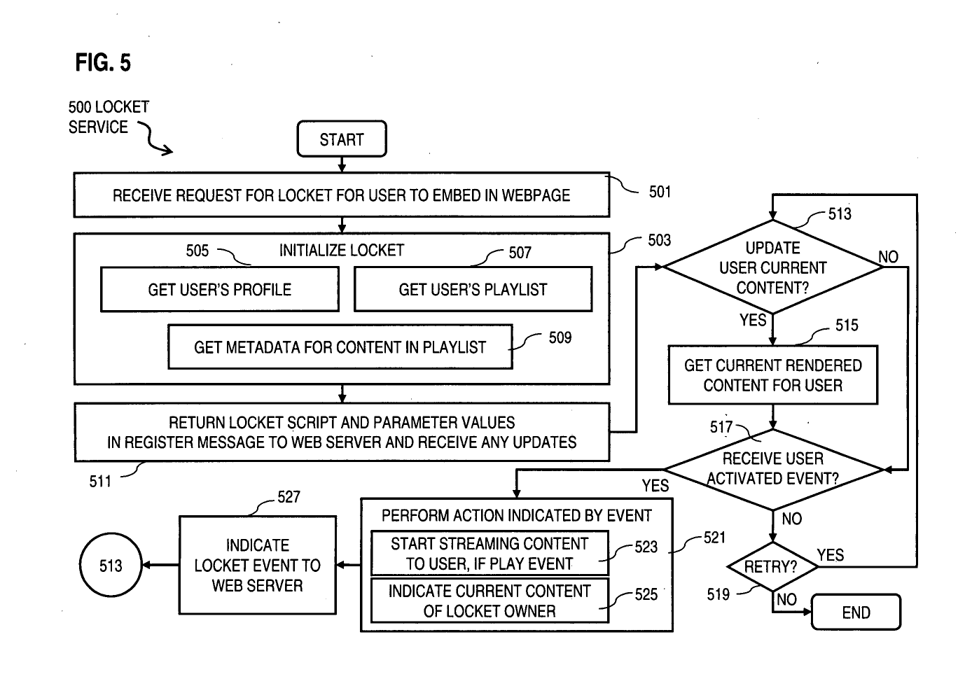

The content locket service process 141 allows content-sharing software objects, or content indicator software objects, called content lockets herein, to be delivered to a user's terminal, as described in more detail below with reference to FIG. 5. Software objects that are self-contained collections of data and methods are widely known and used in object-oriented programming (OOP). Thus, as used herein, a locket is an object that can be embedded in a web page or email or other message for presentation to a user. For convenience, a content locket is referred to as a locket.

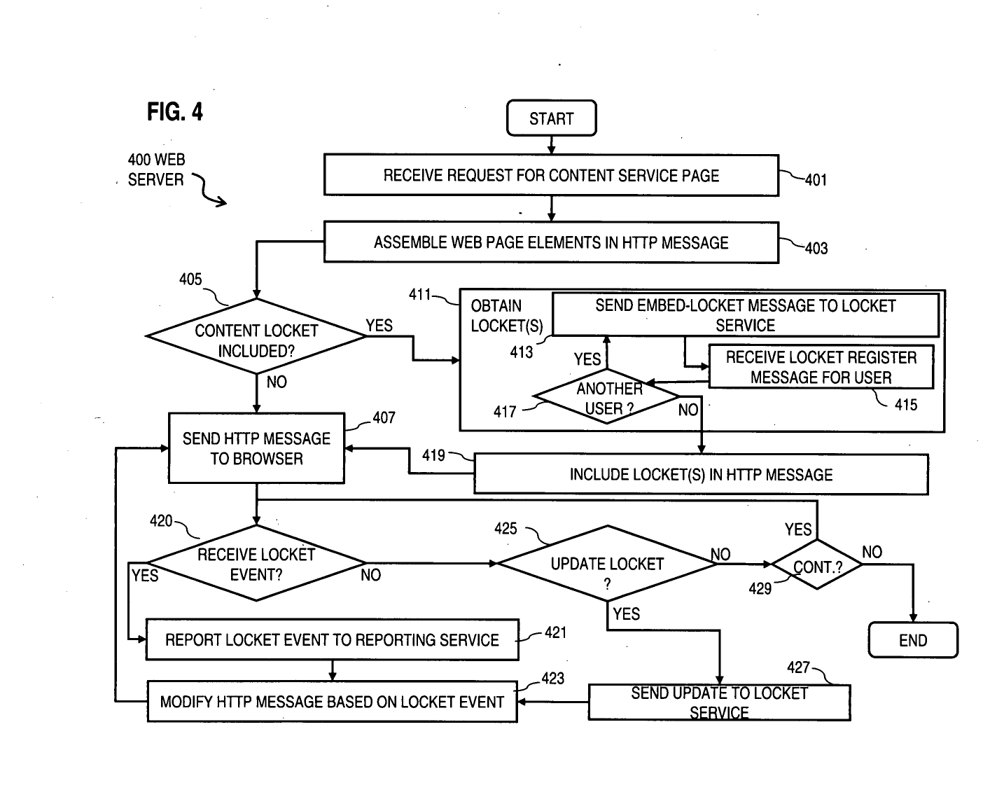

In some embodiments, the web server 119 interacts with the locket service process 141 to embed one or more lockets in one or more web pages delivered to a user's web browser (e.g., browser 117a on mobile terminal 120 or browser 117b on other host 140), as described in more detail below with reference to FIG. 4. Thus web server 119 is depicted as including a web page 115 that includes a locket 143. In other embodiments, lockets are embedded in messages sent by other application servers or clients, e.g., messages sent from email, instant messaging (IM), binary logs (BLOGs) and file transfer servers.

Although a particular set of nodes, processes, and data structures are shown in FIG. 1 for purposes of illustration, in various other embodiments more or fewer nodes, processes and data structures are involved. Furthermore, although processes and data structures are depicted as particular blocks in a particular arrangement for purposes of illustration, in other embodiments each process or data structure, or portions thereof, may be separated or combined or arranged in some other fashion. For example, in some embodiments, played content tracker 137 is a separate parallel process from content service process 133; and, in some embodiments, web server 119 is incorporated within the content services module 133.

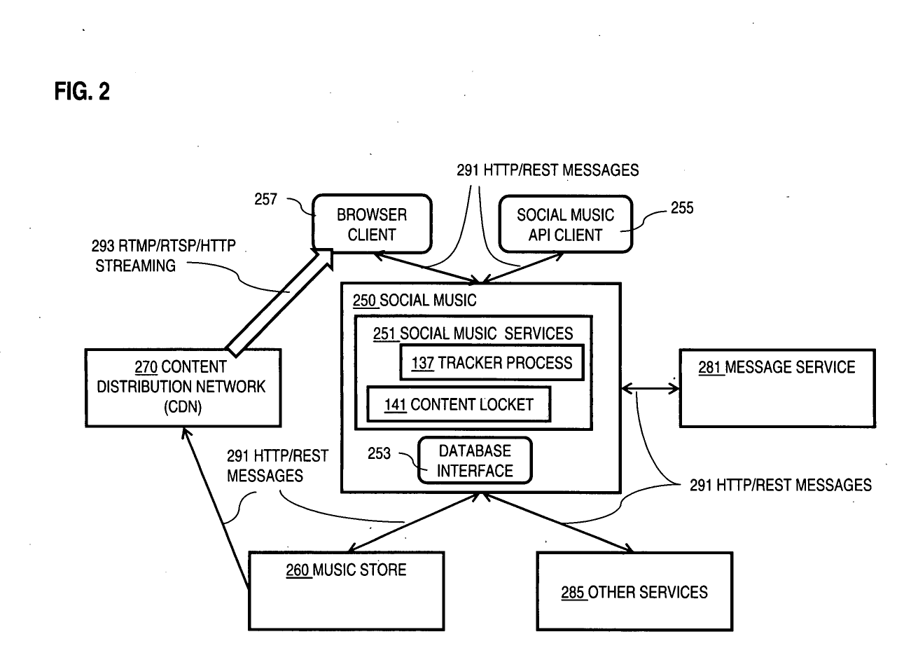

FIG. 2 is a diagram of components of a content service module of the content service system, according to one embodiment. FIG. 2 also shows interaction between the content service module (e.g., content service process 133) and other processes on a network.

In the illustrated embodiment, the content service module is a Social Music module 250 and supports users in finding and playing music on their local devices in communication with the network. The Social Music module 250 includes Social Music services processes 251 and a database interface process 253. The Social Music services 251 are a set of applications (e.g., a Java™ stack written in the Java™ programming language that can be installed and executed on any device that includes a Java™ virtual machine (JVM) process). The Social Music services include instructions for finding songs played by various users and metadata about songs and using the metadata to direct users to resources on the network where the user can sample, purchase or download those songs, alone or in some combination. The database interface process 253 is the interface between the Social Music module 250 and the content database 132; and is used to retrieve and store user information, metadata, and event data, and to retrieve and store content.

In the illustrated embodiment, the Social Music services 251 include played content tracker process 137 to track played content and to use the database interface process 253 to store and retrieve the event data that describes what is being played by whom and when. In the illustrated embodiment, the Social Music services includes a content locket process (or module) 141.

According to the illustrated embodiment, a locket is created to illustrate the taste of a content services user based on that person's content rendering list (i.e., playlist) or content rendering history (i.e., play history). For example, a locket is created to illustrate the musical taste of a Social Music client user based on that person's play list or play history. After the locket is generated in the content service module (e.g., Social Music services module 251), the locket can be emailed to other users in the particular user's social network or posted to a social network web page, such as a Facebook web page, or transferred via an instant messaging (IM) service or BLOG.

For example, a user operates a music locket by interacting with the content locket service (directly or indirectly through a web page) to complete two steps. Step 1, the particular user imports the particular user's own play history (e.g., from last.fm, from yahoo music, or from some other Social Music service). For example, in some embodiments, the musical profile is automatically collected from the music that the particular user listened to with that person's mobile phone based on the playlist 139 in the content database 132. Step 2, the particular user chooses one song as a theme song that best represents the particular user's musical taste, and populates the locket with multiple other songs selected from the user's play history. In many embodiments, the particular user also uploads to the locket an image to represent the user's musical tastes, such as an image of the particular user or an image associated with the theme song.

For example, a music locket module (as an example of the locket service 141) implements a music locket that will play a musical profile of the particular user as 30 second clips of music on the particular user's playlist. The music locket can be embedded in various social web pages or embedded in other messages. Any user in the social network may activate the locket from the social network page (presented to a user via browser client 257) or other message presentation client. The 30 second clips for content in the locket can be played via PC or mobile phone. In an example embodiment, the music locket has direct access to a music store to enable the listener to purchase the song for the clip being played. Thus a user can show off the user's favorite tunes to friends in a social network or other network application. Furthermore, a user can discover and/or purchase one or more favorite songs of a friend in the user's social network or other network application.

The Social Music module 250 interacts with other processes on the network (e.g., network 105) using the hypertext transfer protocol (HTTP), often in concert with the Representational State Transfer (REST) constraints. The other processes may be on the same node or on different nodes.

In some embodiments, a user's device (e.g., mobile terminal 120 or other host 140) includes a Social Music application program interface (API) client 255 to interact with the Social Music module 250, and a browser client 257 to interact with World Wide Web pages using HTTP. In some embodiments, all interactions with the user are through web pages and the user's browser client 257; so that a separate social music API client 255 is omitted. The Social Music module 250 interacts with one or more Music Store systems 260, such as the NOKIA™ Music Store, to purchase songs to be downloaded to a user's device. The download is often accomplished using a Content Distribution Network (CDN) 270. The music store authorizes the CDN 270 to download to the client and then directs a link on the user's browser client 257 to request the content from the CDN 270. The content is delivered to the user through the user's browser client 257 as data formatted, for example, according to HTTP or the real-time messaging protocol (RTMP) or the real-time streaming protocol (RTSP), all well known in the art. As a result, the content is stored as local content 122 on user's device (e.g., mobile terminal 120). The local content 122 arrives on the mobile terminal 120 either directly from the CDN 270, or indirectly through some other device, e.g., a wired node like other host 140, using a temporary connection (not shown) between mobile terminal 120 and other host 140.

In some embodiments, the Social Music module 250 uses a message service 281 to receive event data about playback events on the user's device. In some embodiments, the Social Music module 250 uses other services 285 available on the network (e.g., network 105) such as people services to connect with other persons in a Social Music group of persons, map services to show a user's location and points of interest on a map, and game services to determine the user's status in one or more games.

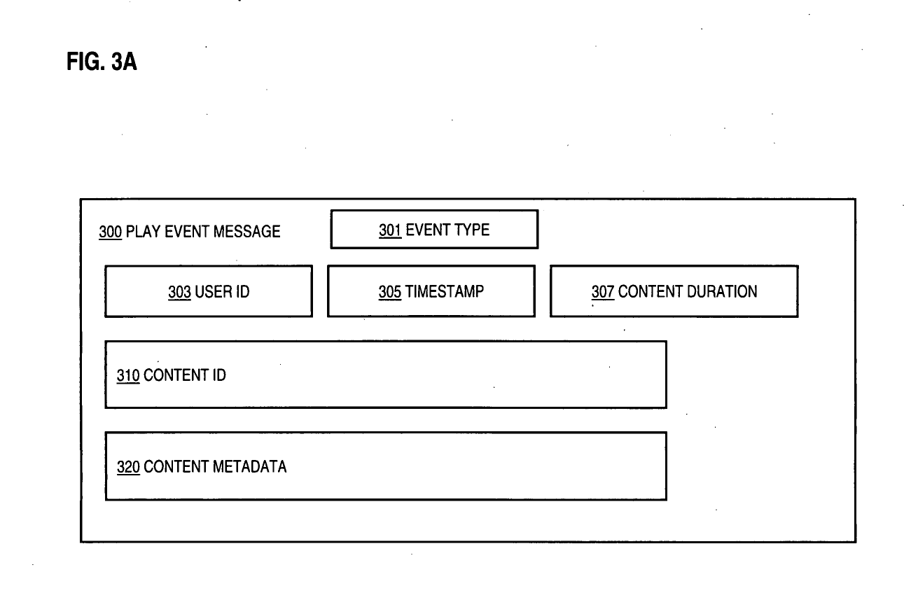

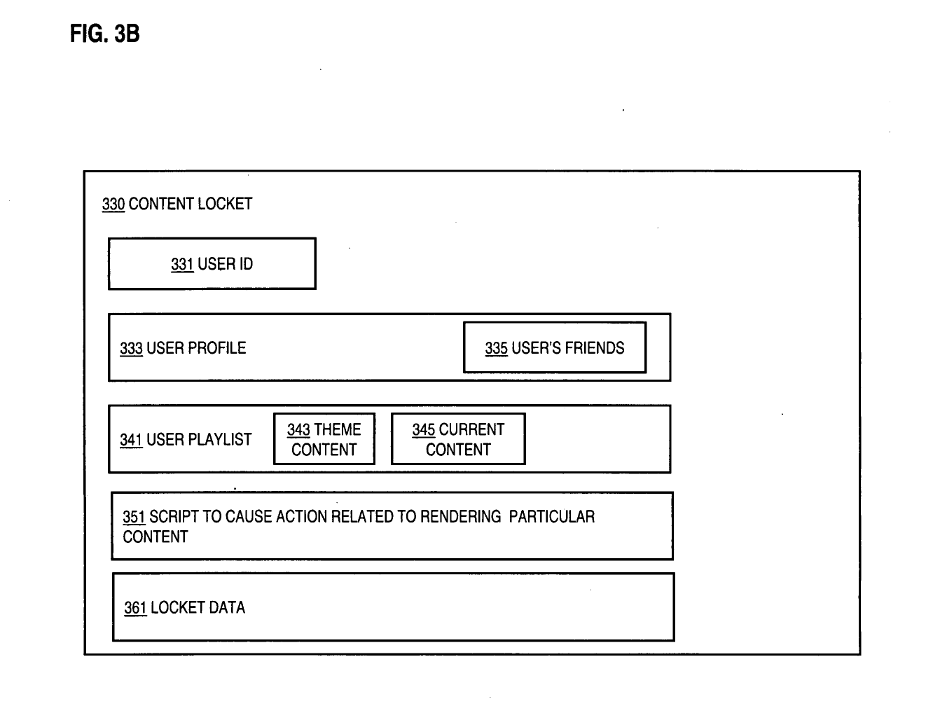

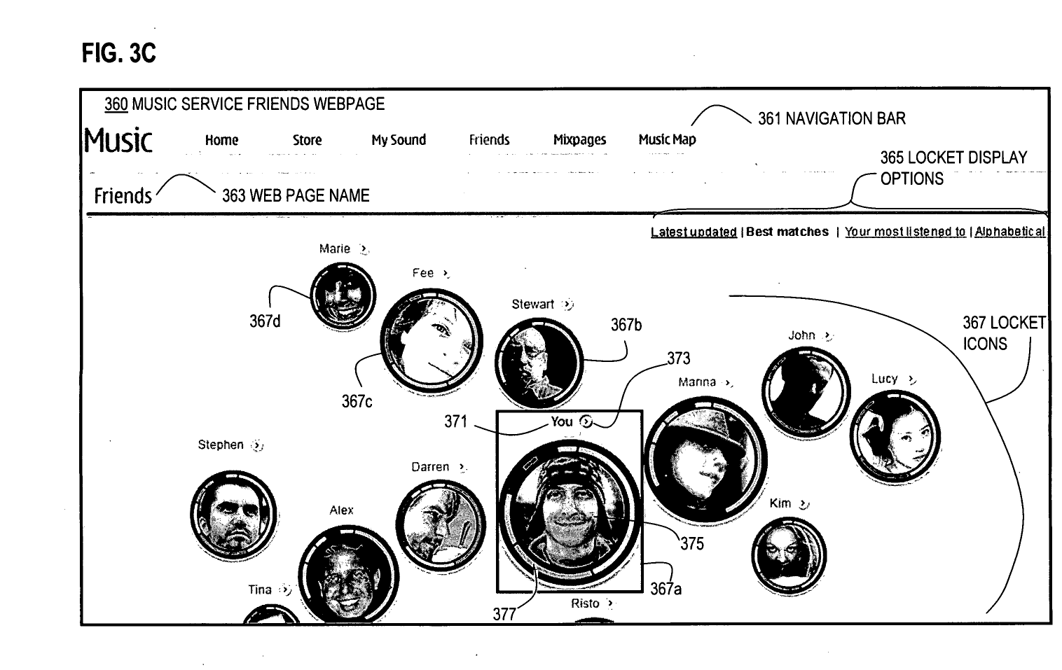

According to the illustrated embodiment, a system of processes to record and share a user's playlist begins with the event generator process 127 on a user device, such as mobile terminal 120. The event generator process 127 determines whether the start of play of some particular content, e.g., a particular song, is detected. If the start of play of some particular content is detected, the process sends the play event. Any method may be used to determine the start of play of content. For example, in some embodiments, the event generator process may monitor commands on an internal bus of the device to detect the retrieval of content from storage or the issuance of a command to a media play process, such as content player 121. An example play event message is described in more detail below with respect to FIG. 3A.

In some embodiments, event messages described below, are sent directly to a content service module 133 (or played content tracker process 137), e.g., using a network address and port number for the destination process. In such embodiments, data is received that indicates the network address and port number of the content service module. Any method may be used to receive this data. For example, in various embodiments, the data is included as a default value in software instructions, is received as manual input from a network administrator on the local or a remote node, is retrieved from a local file or database, or is sent from a different node on the network, either in response to a query or unsolicited, or the data is received using some combination of these methods. In certain embodiments, the event messages are sent via a message service 281.

In some embodiments, the event generator 127 also determines whether a stop play event is detected. Various approaches may be used to determine the stopping of play. For example the event generator process 127 may monitor commands on an internal bus of the device to detect the issuance of a stop command to a media play process, such as content player 121. If a stop play event is detected, a stop play event message is sent. The stop play event message is different from other play event messages. In some embodiments, stop play event messages are not sent.

FIG. 3A is a diagram of a play event message, according to one embodiment. In the illustrated embodiment, the play event message 300 includes an event type field 301, user identifier (ID) field 303, a timestamp field 305, a content duration field 307, a content identifier (ID) field 310 and a content metadata field 320.

The event type field 301 holds data that indicates the type of event being reported in the message, such as a start play event, a stop play event, and a play event that is neither, such as a geolocation event, or continued play event. In some embodiments, such as embodiments that use only start play events, the event type field 301 can be omitted.

The user ID field 303 holds data that indicates a particular user among multiple users of the content service system 130. Any user ID may be used, such as a node identifier for the device used for playback, a user supplied name, an email address, or an ID assigned to a user who registers with the content service system 130. In some embodiments, a user ID is inferred from a node identifier for the device used for playback included in a lower protocol header, and such a field serves as the user ID field 303. In some embodiments, the user ID field 303 is omitted. In some embodiments a user is authenticated and authorized to access the content service system 130 in a separate logon process, not shown, but well known in the art.

The timestamp field 305 holds data that indicates when the event occurred on the device that plays the content. In some embodiments, the timestamp field 305 is omitted.

The content duration field 307 holds data that indicates the time needed to play the content fully for a human user. This field 307, in certain embodiments, can be omitted.

The content ID field 310 holds data that uniquely identifies the content being played. In some embodiments, the field holds data that indicates a name of the content and a name of an artist who generated the content, such as a song title and singer name. In some embodiments, the content ID field 310 holds data that indicates a unique tag or string for the content, such as a value for a retrieval key for the content from the content database 132. The content ID field is not omitted because it is used to form a playlist.

The content metadata field 320 holds metadata information for the content being played, such as an album identifier for an album that includes the song, a name of the content and a name of an artist who generated the content, such as a song title and singer name, content owner, content deliverer, date information, etc. In some embodiments, the content metadata field 320 includes the content duration field 307. In some embodiments, the content metadata field 320 is omitted.

FIG. 3B is a diagram of a content locket 330, according to one embodiment. The locket includes, for example, a user ID field 331, a user profile field 333, a user playlist field 341, script field 351 holding or pointing to script to be executed by a client process in order to cause actions related to particular content from the user's playlist, and/or locket data field 361.

The user ID field 331 holds data that indicates, for example, a user registered with the music services. Any method may be used to indicate the user, as described above with respect to user ID field 303.

The user profile field 333 comprises data that indicates the user profile of the owner of the locket (called owner hereinafter), such as one or more of any of the following: an index for the owner into the users data structure 144; the owner's authorization credentials (such as password for accessing the user's home page); a pointer to the owner's playlist in playlist data structure 139; one or more home pages for the owner on corresponding social networks and/or contact lists; the user's contact information such as email address, an image of the owner, a theme song of the user, a visual theme of the owner, or an avatar of the owner, The example user profile field 333 includes the owner's friends field 335 that holds data that indicates one or more user IDs of other users associated with the owner in the one or more social networks and/or contact lists.

The user's playlist field 341 holds data that indicates the content identifiers (content IDs), like for example 310 and/or 320, for one or more content in the owner's play history, such as values for song name and artist name, or values for a key into the metadata data structure 135 or content data structure 134 or both. In the illustrated embodiment, the user playlist field 341 includes a theme content field 343 and a current content field 345. The theme content field 343 holds data that indicates the one content in the playlist that represents the owner's theme or taste in content, such as a theme song for the owner and/or the owner's top ten songs. The current content field 345 holds data that indicates the one content in the playlist that represents the most recently rendered or currently rendered content rendered by the owner, e.g., the song currently playing on mobile device 120.

The script field 351 holds data for one or more scripts that indicates one or more processes and/or actions to be performed by the locket, such as a process to present the locket to a user and a process to respond to user input associated with the locket, such as playing the owner's theme song, playing the owner's current song, playing short segments (denoted as “snippets”) of all the content in the playlist, playing the owner's top ten list, buying currently/previously playing content, requesting more information about some content, and/or sending messages or otherwise contacting the owner of the locket. As is well known in the art, scripts are instructions that cause a web browser to perform one or more functions. For example, script in the JAVA™ programming language, called a JAVA applet, causes a web browser with a Java engine to perform the steps indicated in the script, as is well known in the art.

The locket data field 361 holds other data used by the locket, such as an image (icon) and/or avatar to represent the locket on a display device, type or form of the locket, such as a circle, bubble, star form, rectangle, cubicle, polyhedron, and/or the percentage of the locket owner's playlist or play history, or both, that falls into each of multiple categories.

FIG. 3C is a diagram of an example web page 360 with multiple lockets embedded thereon, according to an embodiment. The webpage 360 is presented to a particular user of multiple registered users of a content service (e.g., a music service), and includes a navigation bar 361, a web page name 363, locket display options 365, and one or more locket icons 367.

The navigation bar 361 includes active elements that can be selected by user input (e.g., via operation of a pointing device) to move among multiple web pages to be presented to the user, as is well known in the art. The web page name 363 indicates the name for the web page currently presented to the particular user. It is assumed for purposes of illustration that the lockets of the particular user of the web page and the friends of the particular user of the webpage are presented on the web page named “Friends,” depicted in FIG. 3C.

The locket display options 365 includes active elements that can be selected by user input (e.g., via operation of a pointing device) to chose among multiple different ways to present the lockets on the Friends web page. In the illustrated embodiment, the particular user can select among presentations that indicate: the friends' lockets most recently updated; the friends' lockets that most closely match the particular user's own playlist; the friends' lockets whose owners listen to them most; and alphabetical ordering of the friends' lockets.

FIG. 3C depicts the locket icons 367 arranged to indicate the friends' lockets that most closely match the particular user's own playlist. The particular user's own locket icon 367a is depicted along with the locket icons (e.g., locket icons 367b, 367c, 367d) of friends of the particular user. Each locket icon 367, such as locket icon 367a, presents: a name 371 of the locket owner; an active element 373 to play content associated with the locket in response to input from the particular user; an image 375; and a ring 377 of content categories surrounding the image 375. In the illustrated embodiment, the ring is color coded, with each color representing a different category of the content. For example, in social music lockets, the ring categories use different colors to represent each of classical, big band, folk, rhythm and blues, rock and roll, country, heavy metal, grunge, hip-hop, etc. The percent of the ring colored for a particular category matches the percentage of the locket owner's playlist (or play history) that falls in the particular category.

In the illustrated embodiment, the degree of matching is indicated by the proximity of a friend's locket icon to the particular user's locket icon, with the best matches closest. The direction of the friend's locket indicates the category in which the best match occurs by the category on the particular user's ring intersected by a line segment that connects the two locket icons. The size of the locket icon indicates the size of the friend's playlist. Thus locket icon 367b indicates a friend's playlist closest to the particular user for a category at 11 o'clock on the particular user's ring. The next match in such a category is a larger playlist indicated by locket icon 367c, followed by a small playlist indicated by locket icon 367d.

FIG. 4 is a flowchart of a process 400 in a web server to use lockets, according to one embodiment. Although steps in FIG. 4 and subsequent flow chart FIG. 5 are show in a particular order for purposes of illustration, in other embodiments, one or more steps may be performed in a different order or overlapping in time, in series or in parallel, or one or more steps may be omitted or added, or changed in some combination of ways.

In step 401, a request is received for a content service page. For example an HTTP get message is sent from a particular user's web browser with the particular user's authentication credentials, as a result of user input on a prior login page, to a web server 119 for the content service system 130. User authentication and authorization can be performed using well known techniques. In step 403 a web page for the particular user is assembled, either dynamically or statically, based, for example, on the user credentials.

In step 405, it is determined whether one or more locket s are to be included in the web page. For example, it is determined whether the user is known, and if known, whether the user has registered with the locket service. If not, then, during step 407, the web page assembled in step 403 is sent in one or more HTTP messages to the particular user's browser.

However, if it is determined in step 405 that a locket is to be included in the returned web page, the one or more lockets are embedded in the web page during step 411 and step 419. In the illustrated embodiment, step 411 to obtain lockets includes steps 413, 415 and 417.

In step 413, an embed-content-locket message is sent to the locket service. Any protocol may be used to send the embed locket message. In an example embodiment, the embed-content-locket message includes a type field that indicates the message type is an embed-locket type and a user ID field. For example, the message is an HTTP Get message, well known in the art, with data indicating the embed-content-locket type and a value for the user ID. In some embodiments, the locket service 141 has an application program interface (API) and the embed locket message from web server 119 is a locket API client call to the locket service 141.

In response to the embed-content-locket message, during step 415, the web server 119 receives from the locket service 141 a locket for the particular user, such as locket 330. In step 417, it is determined whether the locket for another user is also to be embedded. For example, in an illustrated embodiment, the web server also embeds the lockets of the friends of the particular user. The first locket received for the particular user indicates in field 335 the one or more user IDs of the friends of the particular user and/or the one or more social networks where the particular user is a member. This information is used by the web server to send embed-content-locket messages to the locket service for each of the friends listed in field 335. When lockets are received for all friends of the particular user, then the lockets are included in the HTTP messages that build the web page in step 419 and are sent in step 407 to the particular user's browser 117. During step 419, the lockets are arranged on the web page in any manner, such as in the best matches order depicted in FIG. 3C. The script in each locket controls the display of the individual locket icon on the particular user's web browser 117 when the one or more HTTP messages are received at the particular user's web browser 117. For example, the script generates a GUI that causes actions to be performed when the user interacts with the locket in the user's browser.

When the particular user provides input to select an active element provided by the script of the locket, the script causes the browser 117 to send a content locket event. The locket event indicates an event or action associated with the content indicated in the locket, based on the user input, for example rendering the content. In various embodiments, the one or more active elements presented to the particular user in the browser 117, by the scripts provided in the locket, allow the particular user to perform one or more actions, such as rendering the theme content; rendering snippets of the play list; obtaining and rendering the complete content for one of the contents indicated in the playlist; pausing the rendering of the current content; stopping rendering of the current content; starting the rendering of the next content in the playlist; starting the rendering of the precious content indicated in the playlist, starting rendering the next content of the playlist in a particular category, starting rendering the content currently being rendered by the owner of the locket, requesting more information on the content, requesting supplemental content on the content, contacting owner of the locket, or contacting a service provider to buy the content, among others, or some combination thereof.

In some embodiments, the locket event is sent from the browser 117 back to the web server 119, which forwards the locket event to the locket service 141. However, in other embodiments, the locket event is sent directly from the browser 117 to the locket service 141 or to other processes in the content service module 133. In some of these embodiments, the locket service 141 sends a notice of a locket event to the web server.

In response to receiving a locket event or notice thereof in step 420, the web server reports the locket event to a reporting service in step 421. Thus a locket owner can determine from querying the reporting service, how many times content from that owner's locket has been rendered, or what content has been rendered, how often, what other actions have been taken, or what content has been bought, or some combination thereof. In some embodiments, a reporting service is not used; and step 421 is omitted.

In some embodiments, a modified HTTP message is formed in step 423 based on the locket event or notice received in step 420. For example, a new web page is generated that shows only the locket icon of the locket whose content is being rendered, or the art or other metadata associates with the content is displayed. For example, in various embodiments, when the play element 373 for a friend's locket is selected by the particular user, the presentation of the locket is modified; e.g., the icon is highlighted, a pause button or stop button or next button or previous button or theme button or current button or buy button or contact button or supplemental content button or information button, or some combination thereof, is superimposed or added on the locket, or the image is changed to the cover art of the content being rendered. The modified presentation is indicated in the revised HTTP message formed in step 423 and sent to the particular user's web browser in step 407. In some embodiments, all presentation changes associated with different actions available for the locket are controlled by the locket scripts and step 423 is omitted.

In some embodiments, the web page presented to the particular user by the web browser provides an active element to edit or update the particular user's own locket, separate from the locket icons. Initial generation of a particular user's locket can be performed this way. In such embodiments, the web server receives an HTTP message that is not a locket event or notice thereof. In step 425, it is determined whether such a message to create/edit/update locket is received, for example when the particular user wants to add or change the locket icon image or theme content (e.g., theme song) or remove one or more contents from the user's own playlist. If so, the updated locket information is obtained by the web server 119 and sent to the locket service 141 during step 427 to update one or more values in the fields in the locket 330. In some embodiments, step 427 involves presenting one or more Web forms to the particular user to obtain the new or changed data. Web forms are well known in the art.

The web page is updated in step 423 as a result of the input from the user; and sent to the particular user's web browser in step 407.

In step 429, it is determined whether the process of supporting the lockets should continue. If not, then the process ends. Otherwise, it is again determined in step 420 and step 425 whether an event locket or locket update is received. For example, when the web page receives no HTTP traffic for an extended period of time, e.g., 30 minutes, then it is determined in step 429 to no longer continue, and the process ends.

FIG. 5 is a flowchart of a process 500 at a locket (e.g., locket 143) or locket service (e.g., locket service 141) to provide and render shared content, according to one embodiment. In step 501 a request for a locket owned by a user is received from an application, such as the web page server which will embed the locket in a web page or a web page client that is rendering the web page with the locket. In other embodiments, the request is received from some other application, such as a client or server of an email service, audio or video playback application, game application, map application, or IM or a music services process.

In step 503 the locket is initialized. In some embodiments, step 503 includes updating the locket data, for example, based on one or more messages from the particular user, e.g., through one or more HTTP forms. In the illustrated embodiment, step 503 includes steps 505, 507 and 509. In step 505 the user profiled is obtained. For example, a database command is issued though database interface 253 to get the user profile for the particular user from the users data structure 144 in content service database 132. In the illustrated embodiment, the user's profile includes a list of the user IDs of the particular user's friends in field 335, according to at least some social network site. Some other user profile data, included in various embodiments, are recited above.

In step 507 the user's playlist is obtained. For example, a database command is issued though database interface 253 to get the user playlist for the particular user from the playlist data structure 139 in content service database 132. In the illustrated embodiment, the user's playlists includes a list of content IDs for content rendered by the particular user.

In step 509, at least some metadata for the content identified in the particular user's playlist is obtained. For example, a database command is issued though database interface 253 to get the metadata for one or more contents indicated in the user playlist for the particular user from the metadata data structure 135 in content service database 132. In some embodiments, the metadata (or just the metadata missing from metadata data structure 135) is obtained from metadata provider 111 on network 105. In the illustrated embodiment, the metadata includes links to cover art for content in the particular user's playlist.

Based on the data obtained, e.g., in steps 505, 507 and 509, the locket (e.g., locket 330) is constructed. In some embodiments, the user's profile or the user's playlist indicates the theme content (e.g., theme song) that represents the particular user's style for the content.

In step 511, the locket, e.g., locket 330 including both script in field 341 and values for parameters represented by fields 331, 333, 341 and 361, is returned to the process that requested the locket in step 501, such as the web server 119. In embodiments in which the process is performed by the locket itself already in the webpage, step 511 merely augments the data and scripts already in the locket.

In step 513, it is determined whether it is time to periodically check the current content being rendered by the particular user. If so, then the currently rendered content for the user is obtained in step 515. For example, a database command is issued though database interface 253 to get the event data for the particular user from the event data structure 138 in content service database 132. This event data 138 indicates the previously and currently rendered content detected by event generator 127 on mobile terminal 120 and reported to the played content tracker process 137 in the content service module 133. If not, step 515 is skipped.

In step 517, it is determined whether a message indicating a user activated locket event has been received. In some embodiments, the locket event is received at the locket 143 embedded in the user's application. In some embodiments, such a locket event message is sent in response to user input by the script installed in the user's web browser or other application by the locket, as described above. In some embodiments, the locket event is sent to the locket service 141. In some embodiments, the event is sent first to the web server 119 and relayed by the web server 119 to the locket service 141. The event can be sent by the owner of the locket or by a different user for whom the owner is a friend on a social network. If a user activated locket event is not received in step 517, then it is determined in step 519 whether to wait and retry receiving a message in a little while, by repeating steps 513 and 517. If no retries are attempted, then the process ends.

If, it is determined, in step 517, that a message indicating a user activated locket event has been received, then the action indicated by the locket event is performed in step 521. In the illustrated embodiment, step 521 includes step 523 and step 525. In step 523, the content indicated in a play event message is streamed to the user's web browser. This may be done directly from the locket 143 or locket service 141 using content in content data structure 134 in content database 132, or indirectly through a content distribution network (CDN) service 270. Note that the user may be the owner of the locket or a different user. If the user activated locket event indicates the content currently played by the locket owner is desired by another user, then in step 525, the content currently played is indicated to the user who activated the locket event. For example, the current content being played by the locket owner, as obtained in step 515, is indicated in a message returned to the script process executing in the different user's browser 117.

In step 527, the locket event received in step 517 is indicated to the web server or other application that requested the locket. In some embodiments, the web server forwarded the user activated locket event and step 527 is omitted. Control passes back to step 513 and following steps to see if additional user activated locket events are received.

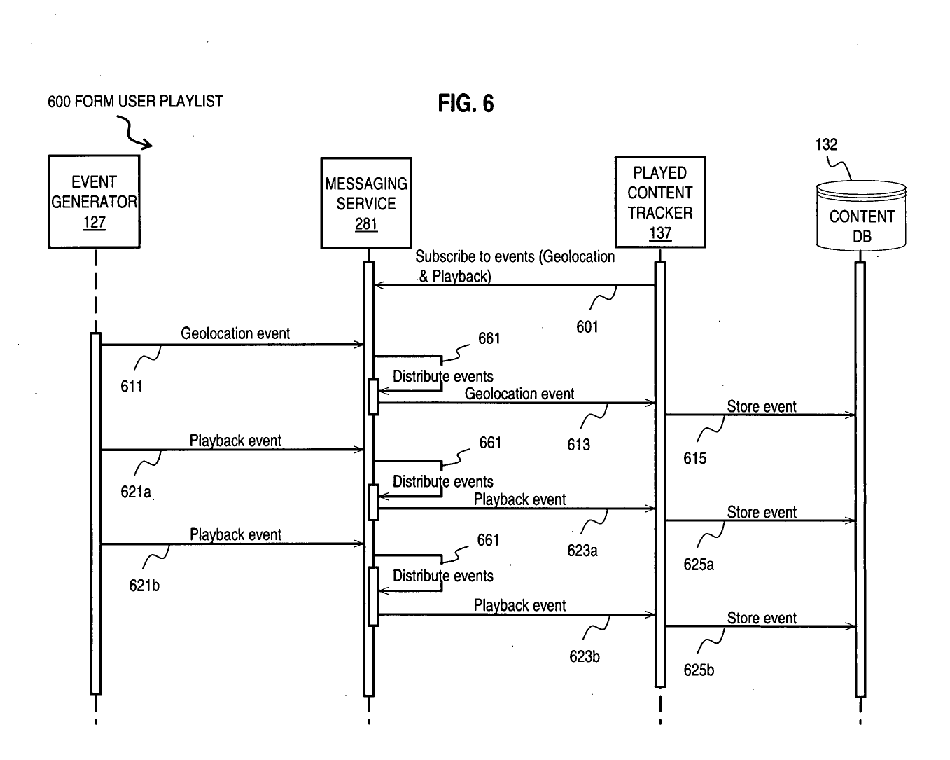

FIG. 6 is a time sequence diagram that illustrates a sequence of messages and processes 600 for tracking content rendering by a user, according to one embodiment. Time increases downward in this and following time sequence diagrams. A network process on the network is represented by a thin vertical box. A message passed from one process to another is represented by horizontal arrows. A step performed by a process is indicated by a box or looping arrow overlapping the process at a time sequence indicated by the vertical position of the box or looping arrow.

The processes represented in FIG. 6 are the event generator 127 on mobile terminal 120, the message service 281, the played content tracker 137 and the content database 132. A register message 601 is sent from the played content tracker 137 to the message service 281 to subscribe (e.g., to request that certain events received at the message service 281 be forwarded to the played content tracker 137). For example, the played content tracker 137 requests that geolocation events and play events from a mobile device be forwarded.

The event generator 127 detects conditions for sending a geolocation event (e.g., the mobile device has been turned on or has moved to a cell of a new base station) and sends a geolocation event message 611. In process 661, the message service 281 distributes this event message to all subscribers for it, including the played content tracker 137. The message service 281 forwards geolocation event message 613, based on received message 611, to the played content tracker 137. The played content tracker 137 issues message 615 to store the geolocation event in the content database 132. For example, the played content tracker 137 in the Social Music service issues a command to the database interface 153 to store one or more fields of the geolocation event message.

Similarly, the event generator 127 detects conditions for sending a play event (called herein a playback event, e.g., a user of the mobile terminal starts playing a particular song) and sends a playback event message, e.g., one of playback event messages 621a and 621b. In process 661, the message service 281 distributes these playback event messages, in turn, to all subscribers for them, including the played content tracker 137. The message service 281 forwards playback event message 623a and 623b, based on received messages 621a and 621b, respectively, to the played content tracker 137. The played content tracker 137 issues messages 625a and 625b to store the playback events in the content database 132, such as by issuing database interface commands to store one or more fields of the playback event messages 623a and 623b. Thus event data is stored in event data structure 138. In some embodiments, the played content tracker then determines a playlist or play history for a particular user and stores data indicating that in playlist data structure 139.

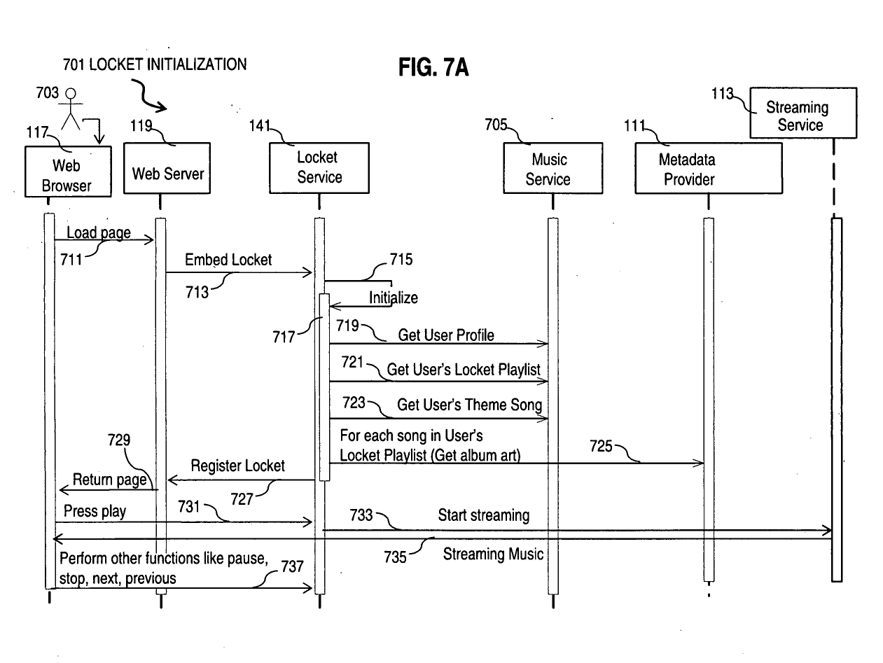

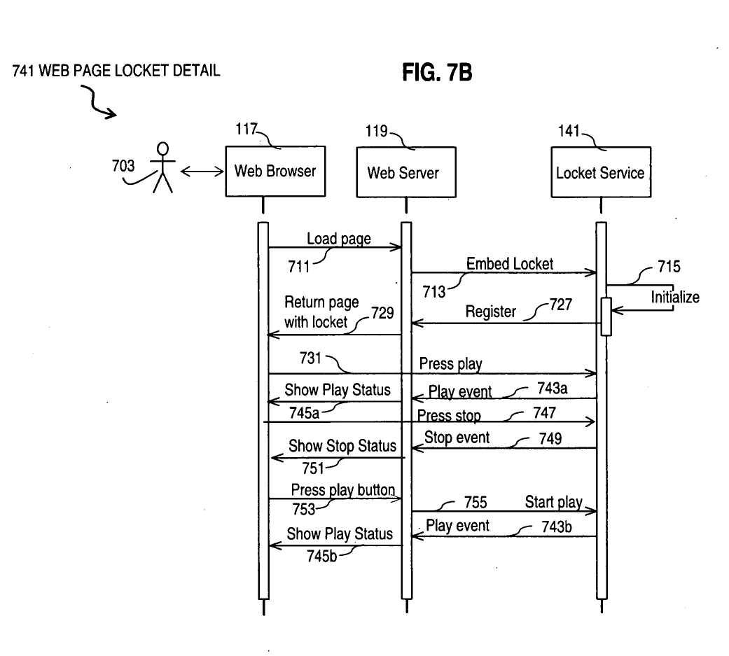

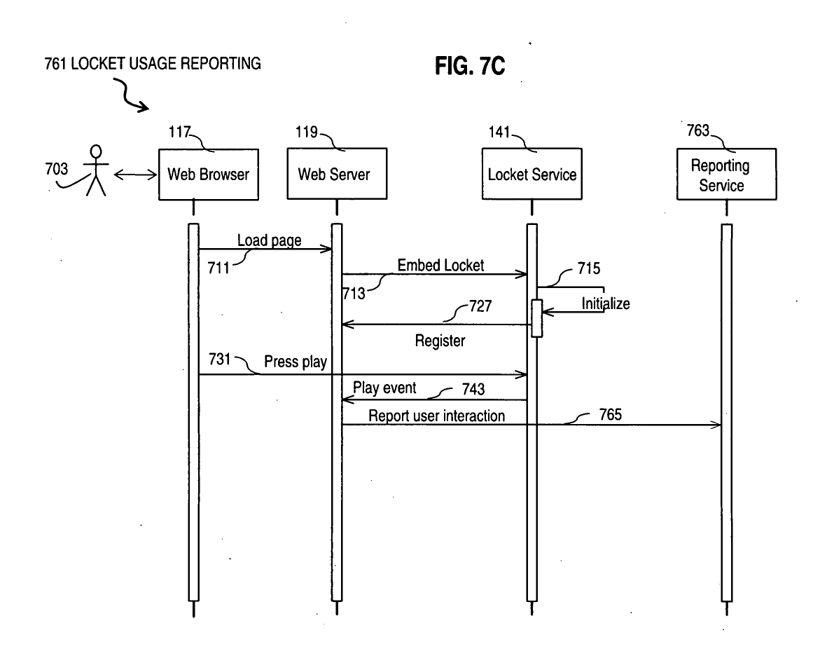

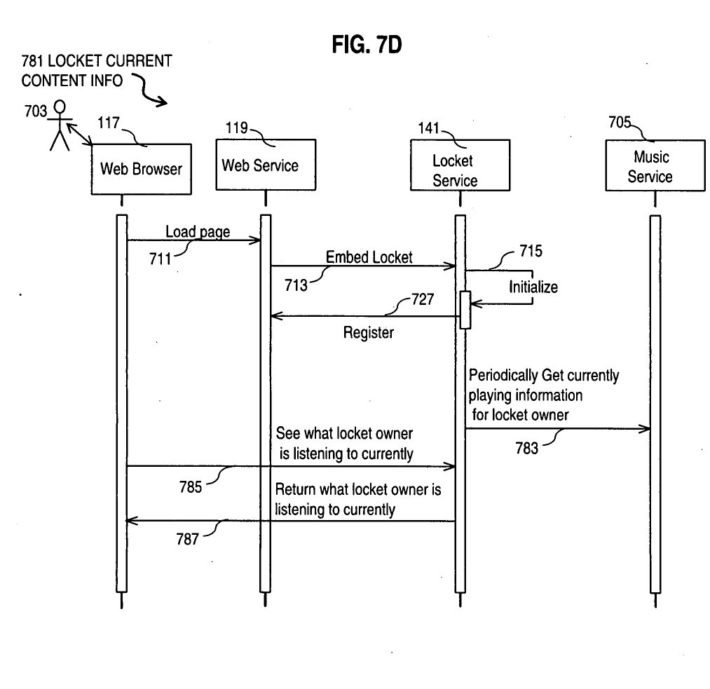

FIG. 7A is a time sequence diagram that illustrates a sequence of messages and processes 701 for initializing and embedding a content locket in a web page, according to one embodiment. The processes represented in FIG. 7A are the web browser 117, the Web server 119, the locket service 141, a music service 705 (such as a social music process 250 version of content service module 133) a metadata provider 111 (such as a music store 260) and a streaming service 113 (such as CDN 270). A user 703 provides input to web browser 117. In some embodiments, some or all of the messages and processes depicted for locket service 141 are performed by the locket 143 embedded in an application, such as web browser 117.

A load page HTTP message 711 is sent to the Web server 119 for the content service based on user 703 input. The load page message includes a user ID for an authenticated user authorized to access the music service. The Web server 119 begins assembling the web page and sends an embed locket message 713 to obtain the locket for the user 703. In process 715, the locket service 141 initializes the locket including any data and scripts. To complete the locket, the locket or locket service issues messages depicted as database commands to get user profile 719, get user's locket playlist 721, and get user's theme song 723 from the music service 705 and its database (like content database 132). For each song in the user's playlist, a message 725 is sent to the metadata provider to obtain metadata for that song, such as album art. These messages are expressed as a database interface command to get album art. Data is returned to the locket service 141 in response to these get commands, as is well known in the art, but is not depicted in FIG. 7A to avoid obscuring this embodiment of the invention. The locket service 141 constructs the locket based on the data returned and registers the locket with the web server in message 727, e.g., by sending the locket or its link (e.g., a universal resource locator, URL, name) to the web server 119. The Web server 119 sends the web page to the web browser 117 in HTTP messages 729.

The user provides input to the locket element (e.g., active element 373) visible on the web page to activate the play content button. The play content event message 731 is sent to the locket service 141 (bypassing the web server 119, in the depicted embodiment). The locket service 141 causes the action to be performed, such as by sending a start streaming message 733 to the streaming service 113 with the network address of the user's browser 117. The snippet or full duration of the selected content is streamed to the user's browser 117 in messages 735. Alternatively, the start streaming message 733 may be sent first to the music service 705 that streams the content to user's browser 117, or which further sends the message to the streaming service 113. Additionally, in some embodiments, a buy content message is sent to the locket service 141 that causes the locket service 141 to send the buy content message to the music service 705, or some other service provider.

Based on user input to active elements depicted in the browser by the locket scripts, one or more other messages 737 are sent from the browser 117 to the locket service 141 to perform one or more other actions, such as pause, stop, next, previous, identify owner's currently rendering content. In response, the locket service 141 causes the action to be performed.

FIG. 7B is a time sequence diagram that illustrates a sequence of messages and processes 741 for detailed web page interactions with a locket service, according to one embodiment. The processes represented in FIG. 7B are the web browser 117, the Web server 119, and the locket service 141. A user 703 provides input to web browser 117. In certain embodiments, some or all of the messages and processes depicted for locket service 141 are performed by the locket 143 embedded in an application, such as web browser 117.

The load page message 711, embed locket message 713, initialize process 715, register message 727, return page message 729 and press play message 731 are as described above for FIG. 7A.

In the illustrated embodiment, a play event message 743a is sent from the locket service 141 to the Web server 119 to indicate that content in the locket included in the web page has been selected for rendering by the user 703. In the illustrated embodiment, the Web Server sends an HTTP message 745a to indicate the play status of the locket. This causes the presentation of the locket to change on the Web browser 117, e.g., by screening out the locket or superposing one or more buttons that are active when a song is playing. Similarly, when the user 703 selects a stop button, the script in the locket in the Web browser 117 sends a press stop message 747 to the locket service 141, and a stop event message 749 is sent from the locket service 141 to the Web server 119. In the illustrated embodiment, the Web Server sends an HTTP message 751 to indicate the play status of the locket. This causes the presentation of the locket to change on the Web browser, e.g., by screening out the locket or superposing one or more buttons that are active when a song is stopped.

In the illustrated embodiment, a press play button message 753 is sent to the Web server 119 instead of to the locket service 141. The Web server 119 forwards a start play event message 755 to the locket service. In response, the locket causes the content to play; and, a play event message 743b is sent from the locket service 141 to the Web server 119 to indicate that the content of the locket included in the web page has been selected by the user 703 for rendering. The Web Server 119 sends an HTTP message 745b to the Web browser 117 to indicate the play status of the locket. This causes the presentation of the locket to change on the Web browser.

FIG. 7C is a time sequence diagram that illustrates a sequence of messages and processes 761 for reporting locket usage, according to one embodiment. The processes represented in FIG. 7C are the web browser 117, the Web server 119, the locket service 141, and the reporting service 763. A user 703 provides input to web browser 117. In certain embodiments, some or all of the messages and processes depicted for locket service 141 are performed by the locket 143 embedded in an application, e.g., in web browser 117.

The load page message 711, embed locket message 713, initialize process 715, register message 727, return page message 729, press play message 731 and play event message 743 are as described above for FIG. 7B. In the illustrated embodiment, the Web server reports the locket event to the reporting service in one or more message 765. Any reporting service and associated reporting message format may be used. Thus a locket owner can determine from the reporting service who reviewed his content, when, and how often.

FIG. 7D is a time sequence diagram that illustrates a sequence of messages and processes 781 for determining current rendering of content, according to one embodiment. The processes represented in FIG. 7C are the web browser 117, the Web server 119, the locket service 141, and the music service 705. A user 703 provides input to web browser 117. In certain embodiments, some or all of the messages and processes depicted for locket service 141 are performed by the locket 143 embedded in an application, e.g., in web browser 117.

The load page message 711, embed locket message 713, initialize process 715 and register message 727 are as described above for FIG. 7A. In the illustrated embodiment, the locket service periodically gets data indicating the content currently being rendered by the owner of the locket, in one or more message 783 expressed as a database command. The currently playing information is obtained from the event data 138 in the content database 132. Data is returned to the locket service 141 in response to these get commands, as is well known in the art, but is not depicted in FIG. 7D to avoid obscuring this embodiment of the invention.

In response to input from the user 703 on active elements presented by the script in the embedded locket, the web browser 117 sends one or more messages 785 indicating a desire to obtain information on what the locket owner is currently playing. Based on the content currently playing, as determined in response to query message 783, the locket service has the requested information. In one or more messages 787, the locket service 141 returns data that indicates what the locket owner is currently playing (e.g., what music the locket owner is currently listening to). The user can then determine whether to listen to the same music and can send a message indicating a play event for that music.

The processes described herein for tracking and sharing content playback may be implemented via software, hardware (e.g., general processor, Digital Signal Processing (DSP) chip, an Application Specific Integrated Circuit (ASIC), Field Programmable Gate Arrays (FPGAs), etc.), firmware or a combination thereof. Such example hardware for performing the described functions is detailed below.

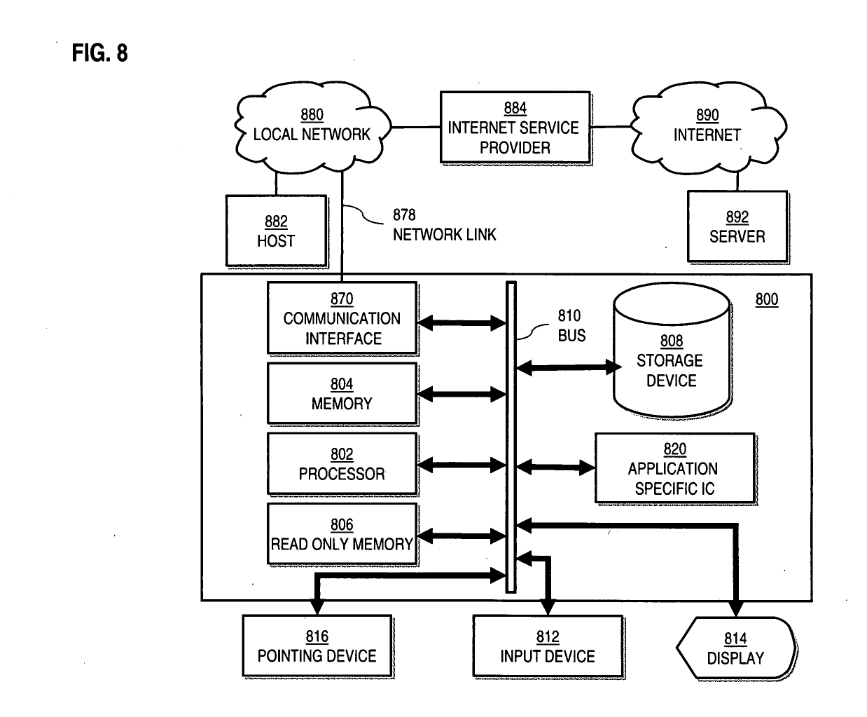

FIG. 8 illustrates a computer system 800 upon which an embodiment of the invention may be implemented. Computer system 800 includes a communication mechanism such as a bus 810 for passing information between other internal and external components of the computer system 800. Information (also called data) is represented as a physical expression of a measurable phenomenon, typically electric voltages, but including, in other embodiments, such phenomena as magnetic, electromagnetic, pressure, chemical, biological, molecular, atomic, sub-atomic and quantum interactions. For example, north and south magnetic fields, or a zero and non-zero electric voltage, represent two states (0, 1) of a binary digit (bit). Other phenomena can represent digits of a higher base. A superposition of multiple simultaneous quantum states before measurement represents a quantum bit (qubit). A sequence of one or more digits constitutes digital data that is used to represent a number or code for a character. In some embodiments, information called analog data is represented by a near continuum of measurable values within a particular range.

A bus 810 includes one or more parallel conductors of information so that information is transferred quickly among devices coupled to the bus 810. One or more processors 802 for processing information are coupled with the bus 810.

A processor 802 performs a set of operations on information. The set of operations include bringing information in from the bus 810 and placing information on the bus 810. The set of operations also typically include comparing two or more units of information, shifting positions of units of information, and combining two or more units of information, such as by addition or multiplication or logical operations like OR, exclusive OR (XOR), and AND. Each operation of the set of operations that can be performed by the processor is represented to the processor by information called instructions, such as an operation code of one or more digits. A sequence of operations to be executed by the processor 802, such as a sequence of operation codes, constitute processor instructions, also called computer system instructions or, simply, computer instructions. Processors may be implemented as mechanical, electrical, magnetic, optical, chemical or quantum components, among others, alone or in combination.

Computer system 800 also includes a memory 804 coupled to bus 810. The memory 804, such as a random access memory (RAM) or other dynamic storage device, stores information including processor instructions. Dynamic memory allows information stored therein to be changed by the computer system 800. RAM allows a unit of information stored at a location called a memory address to be stored and retrieved independently of information at neighboring addresses. The memory 804 is also used by the processor 802 to store temporary values during execution of processor instructions. The computer system 800 also includes a read only memory (ROM) 806 or other static storage device coupled to the bus 810 for storing static information, including instructions, that is not changed by the computer system 800. Some memory is composed of volatile storage that loses the information stored thereon when power is lost. Also coupled to bus 810 is a non-volatile (persistent) storage device 808, such as a magnetic disk, optical disk or flash card, for storing information, including instructions, that persists even when the computer system 800 is turned off or otherwise loses power.

Information, including instructions, is provided to the bus 810 for use by the processor from an external input device 812, such as a keyboard containing alphanumeric keys operated by a human user, or a sensor. A sensor detects conditions in its vicinity and transforms those detections into physical expression compatible with the measurable phenomenon used to represent information in computer system 800. Other external devices coupled to bus 810, used primarily for interacting with humans, include a display device 814, such as a cathode ray tube (CRT) or a liquid crystal display (LCD), or plasma screen or printer for presenting text or images, and a pointing device 816, such as a mouse or a trackball or cursor direction keys, or motion sensor, for controlling a position of a small cursor image presented on the display 814 and issuing commands associated with graphical elements presented on the display 814. In some embodiments, for example, in embodiments in which the computer system 800 performs all functions automatically without human input, one or more of external input device 812, display device 814 and pointing device 816 is omitted.

In the illustrated embodiment, special purpose hardware, such as an application specific integrated circuit (ASIC) 820, is coupled to bus 810. The special purpose hardware is configured to perform operations not performed by processor 802 quickly enough for special purposes. Examples of application specific ICs include graphics accelerator cards for generating images for display 814, cryptographic boards for encrypting and decrypting messages sent over a network, speech recognition, and interfaces to special external devices, such as robotic arms and medical scanning equipment that repeatedly perform some complex sequence of operations that are more efficiently implemented in hardware.

Computer system 800 also includes one or more instances of a communications interface 870 coupled to bus 810. Communication interface 870 provides a one-way or two-way communication coupling to a variety of external devices that operate with their own processors, such as printers, scanners and external disks. In general the coupling is with a network link 878 that is connected to a local network 880 to which a variety of external devices with their own processors are connected. For example, communication interface 870 may be a parallel port or a serial port or a universal serial bus (USB) port on a personal computer. In some embodiments, communications interface 870 is an integrated services digital network (ISDN) card or a digital subscriber line (DSL) card or a telephone modem that provides an information communication connection to a corresponding type of telephone line. In some embodiments, a communication interface 870 is a cable modem that converts signals on bus 810 into signals for a communication connection over a coaxial cable or into optical signals for a communication connection over a fiber optic cable. As another example, communications interface 870 may be a local area network (LAN) card to provide a data communication connection to a compatible LAN, such as Ethernet. Wireless links may also be implemented. For wireless links, the communications interface 870 sends or receives or both sends and receives electrical, acoustic or electromagnetic signals, including infrared and optical signals, that carry information streams, such as digital data. For example, in wireless handheld devices, such as mobile telephones like cell phones, the communications interface 870 includes a radio band electromagnetic transmitter and receiver called a radio transceiver.

The term computer-readable medium is used herein to refer to any medium that participates in providing information to processor 802, including instructions for execution. Such a medium may take many forms, including, but not limited to, non-volatile media, volatile media and transmission media. Non-volatile media include, for example, optical or magnetic disks, such as storage device 808. Volatile media include, for example, dynamic memory 804. Transmission media include, for example, coaxial cables, copper wire, fiber optic cables, and carrier waves that travel through space without wires or cables, such as acoustic waves and electromagnetic waves, including radio, optical and infrared waves. Signals include man-made transient variations in amplitude, frequency, phase, polarization or other physical properties transmitted through the transmission media.

Common forms of computer-readable media include, for example, a floppy disk, a flexible disk, a hard disk, a magnetic tape, or any other magnetic medium, a compact disk ROM (CD-ROM), a digital video disk (DVD) or any other optical medium, punch cards, paper tape, or any other physical medium with patterns of holes, a RAM, a programmable ROM (PROM), an erasable PROM (EPROM), a FLASH-EPROM, or any other memory chip or cartridge, a transmission medium such as a cable or carrier wave, or any other medium from which a computer can read. Information read by a computer from computer-readable media are variations in physical expression of a measurable phenomenon on the computer readable medium. Computer-readable storage medium is a subset of computer-readable medium which excludes transmission media that carry transient man-made signals.

Logic encoded in one or more tangible media includes one or both of processor instructions on a computer-readable storage media and special purpose hardware, such as ASIC 820.

Network link 878 typically provides information communication using transmission media through one or more networks to other devices that use or process the information. For example, network link 878 may provide a connection through local network 880 to a host computer 882 or to equipment 884 operated by an Internet Service Provider (ISP). ISP equipment 884 in turn provides data communication services through the public, world-wide packet-switching communication network of networks now commonly referred to as the Internet 890. A computer called a server host 892 connected to the Internet hosts a process that provides a service in response to information received over the Internet. For example, server host 892 hosts a process that provides information representing video data for presentation at display 814.

At least some embodiments of the invention are related to the use of computer system 800 for implementing some or all of the techniques described herein. According to one embodiment of the invention, those techniques are performed by computer system 800 in response to processor 802 executing one or more sequences of one or more processor instructions contained in memory 804. Such instructions, also called computer instructions, software and program code, may be read into memory 804 from another computer-readable medium such as storage device 808 or network link 878. Execution of the sequences of instructions contained in memory 804 causes processor 802 to perform one or more of the method steps described herein. In alternative embodiments, hardware, such as ASIC 820, may be used in place of or in combination with software to implement the invention. Thus, embodiments of the invention are not limited to any specific combination of hardware and software, unless otherwise explicitly stated herein.

The signals transmitted over network link 878 and other networks through communications interface 870, carry information to and from computer system 800. Computer system 800 can send and receive information, including program code, through the networks 880, 890 among others, through network link 878 and communications interface 870. In an example using the Internet 890, a server host 892 transmits program code for a particular application, requested by a message sent from computer 800, through Internet 890, ISP equipment 884, local network 880 and communications interface 870. The received code may be executed by processor 802 as it is received, or may be stored in memory 804 or in storage device 808 or other non-volatile storage for later execution, or both. In this manner, computer system 800 may obtain application program code in the form of signals on a carrier wave.

Various forms of computer readable media may be involved in carrying one or more sequence of instructions or data or both to processor 802 for execution. For example, instructions and data may initially be carried on a magnetic disk of a remote computer such as host 882. The remote computer loads the instructions and data into its dynamic memory and sends the instructions and data over a telephone line using a modem. A modem local to the computer system 800 receives the instructions and data on a telephone line and uses an infra-red transmitter to convert the instructions and data to a signal on an infra-red carrier wave serving as the network link 878. An infrared detector serving as communications interface 870 receives the instructions and data carried in the infrared signal and places information representing the instructions and data onto bus 810. Bus 810 carries the information to memory 804 from which processor 802 retrieves and executes the instructions using some of the data sent with the instructions. The instructions and data received in memory 804 may optionally be stored on storage device 808, either before or after execution by the processor 802.

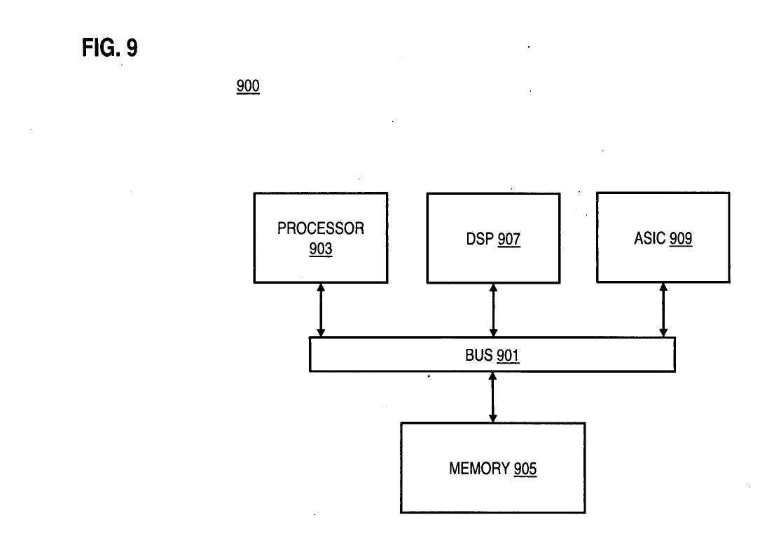

FIG. 9 illustrates a chip set 900 upon which an embodiment of the invention may be implemented. Chip set 900 is programmed to carry out the inventive functions described herein and includes, for instance, the processor and memory components described with respect to FIG. 9 incorporated in one or more physical packages. By way of example, a physical package includes an arrangement of one or more materials, components, and/or wires on a structural assembly (e.g., a baseboard) to provide one or more characteristics such as physical strength, conservation of size, and/or limitation of electrical interaction.

In one embodiment, the chip set 900 includes a communication mechanism such as a bus 901 for passing information among the components of the chip set 900. A processor 903 has connectivity to the bus 901 to execute instructions and process information stored in, for example, a memory 905. The processor 903 may include one or more processing cores with each core configured to perform independently. A multi-core processor enables multiprocessing within a single physical package. Examples of a multi-core processor include two, four, eight, or greater numbers of processing cores. Alternatively or in addition, the processor 903 may include one or more microprocessors configured in tandem via the bus 901 to enable independent execution of instructions, pipelining, and multithreading. The processor 903 may also be accompanied with one or more specialized components to perform certain processing functions and tasks such as one or more digital signal processors (DSP) 907, or one or more application-specific integrated circuits (ASIC) 909. A DSP 907 typically is configured to process real-word signals (e.g., sound) in real time independently of the processor 903. Similarly, an ASIC 909 can be configured to performed specialized functions not easily performed by a general purposed processor. Other specialized components to aid in performing the inventive functions described herein include one or more field programmable gate arrays (FPGA) (not shown), one or more controllers (not shown), or one or more other special-purpose computer chips.

The processor 903 and accompanying components have connectivity to the memory 905 via the bus 901. The memory 905 includes both dynamic memory (e.g., RAM, magnetic disk, writable optical disk, etc.) and static memory (e.g., ROM, CD-ROM, etc.) for storing executable instructions that when executed perform the inventive steps described herein. The memory 905 also stores the data associated with or generated by the execution of the inventive steps.

FIG. 10 is a diagram of example components of a mobile station (e.g., handset) capable of operating in the system of FIG. 1, according to one embodiment. Generally, a radio receiver is often defined in terms of front-end and back-end characteristics. The front-end of the receiver encompasses all of the Radio Frequency (RF) circuitry whereas the back-end encompasses all of the base-band processing circuitry. Pertinent internal components of the station include a Main Control Unit (MCU) 1003, a Digital Signal Processor (DSP) 1005, and a receiver/transmitter unit including a microphone gain control unit and a speaker gain control unit. A main display unit 1007 provides a display to the user in support of various applications and mobile station functions. An audio function circuitry 1009 includes a microphone 1011 and microphone amplifier that amplifies the speech signal output from the microphone 1011. The amplified speech signal output from the microphone 1011 is fed to a coder/decoder (CODEC) 1013.

A radio section 1015 amplifies power and converts frequency in order to communicate with a base station, which is included in a mobile communication system, via antenna 1017. The power amplifier (PA) 1019 and the transmitter/modulation circuitry are operationally responsive to the MCU 1003, with an output from the PA 1019 coupled to the duplexer 1021 or circulator or antenna switch, as known in the art. The PA 1019 also couples to a battery interface and power control unit 1020.

In use, a user of mobile station 1001 speaks into the microphone 1011 and his or her voice along with any detected background noise is converted into an analog voltage. The analog voltage is then converted into a digital signal through the Analog to Digital Converter (ADC) 1023. The control unit 1003 routes the digital signal into the DSP 1005 for processing therein, such as speech encoding, channel encoding, encrypting, and interleaving. In the example embodiment, the processed voice signals are encoded, by units not separately shown, using a cellular transmission protocol such as global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., microwave access (WiMAX), Long Term Evolution (LTE) networks, code division multiple access (CDMA), wireless fidelity (WiFi), satellite, and the like.

The encoded signals are then routed to an equalizer 1025 for compensation of any frequency-dependent impairments that occur during transmission though the air such as phase and amplitude distortion. After equalizing the bit stream, the modulator 1027 combines the signal with a RF signal generated in the RF interface 1029. The modulator 1027 generates a sine wave by way of frequency or phase modulation. In order to prepare the signal for transmission, an up-converter 1031 combines the sine wave output from the modulator 1027 with another sine wave generated by a synthesizer 1033 to achieve the desired frequency of transmission. The signal is then sent through a PA 1019 to increase the signal to an appropriate power level. In practical systems, the PA 1019 acts as a variable gain amplifier whose gain is controlled by the DSP 1005 from information received from a network base station. The signal is then filtered within the duplexer 1021 and optionally sent to an antenna coupler 1035 to match impedances to provide maximum power transfer. Finally, the signal is transmitted via antenna 1017 to a local base station. An automatic gain control (AGC) can be supplied to control the gain of the final stages of the receiver. The signals may be forwarded from there to a remote telephone which may be another cellular telephone, other mobile phone or a land-line connected to a Public Switched Telephone Network (PSTN), or other telephony networks.

Voice signals transmitted to the mobile station 1001 are received via antenna 1017 and immediately amplified by a low noise amplifier (LNA) 1037. A down-converter 1039 lowers the carrier frequency while the demodulator 1041 strips away the RF leaving only a digital bit stream. The signal then goes through the equalizer 1025 and is processed by the DSP 1005. A Digital to Analog Converter (DAC) 1043 converts the signal and the resulting output is transmitted to the user through the speaker 1045, all under control of a Main Control Unit (MCU) 1003-which can be implemented as a Central Processing Unit (CPU) (not shown).

The MCU 1003 receives various signals including input signals from the keyboard 1047. The MCU 1003 delivers a display command and a switch command to the display 1007 and to the speech output switching controller, respectively. Further, the MCU 1003 exchanges information with the DSP 1005 and can access an optionally incorporated SIM card 1049 and a memory 1051. In addition, the MCU 1003 executes various control functions required of the station. The DSP 1005 may, depending upon the implementation, perform any of a variety of conventional digital processing functions on the voice signals. Additionally, DSP 1005 determines the background noise level of the local environment from the signals detected by microphone 1011 and sets the gain of microphone 1011 to a level selected to compensate for the natural tendency of the user of the mobile station 1001.

The CODEC 1013 includes the ADC 1023 and DAC 1043. The memory 1051 stores various data including call incoming tone data and is capable of storing other data including music data received via, e.g., the global Internet. The software module could reside in RAM memory, flash memory, registers, or any other form of writable storage medium known in the art. The memory device 1051 may be, but not limited to, a single memory, CD, DVD, ROM, RAM, EEPROM, optical storage, or any other non-volatile storage medium capable of storing digital data.

An optionally incorporated SIM card 1049 carries, for instance, important information, such as the cellular phone number, the carrier supplying service, subscription details, and security information. The SIM card 1049 serves primarily to identify the mobile station 1001 on a radio network. The card 1049 also contains a memory for storing a personal telephone number registry, text messages, and user specific mobile station settings.

While the invention has been described in connection with a number of embodiments and implementations, the invention is not so limited but covers various obvious modifications and equivalent arrangements, which fall within the purview of the appended claims. Although features of the invention are expressed in certain combinations among the claims, it is contemplated that these features can be arranged in any combination and order.

What is claimed is:

1. A computer-readable storage medium carrying one or more sequences of one or more instructions which, when executed by one or more processors, cause the one or more processors to perform at least the following:
receiving a request for a content locket for a user, wherein the content locket includes
data indicating a content playlist associated with the user, and
script for generating a message that requests an action related to content indicated in the content playlist;
initiating forwarding of the content locket; and
in response to receiving the message generated by the script, performing the action related to the content.

2. A computer-readable storage medium of claim 1, wherein the action related to the content includes one of starting a rendering of the content, stopping the rendering, or pausing the rendering.

3. A computer-readable storage medium of claim 1, wherein the action related to the content includes starting a rendering of content that is currently being rendered by the user.

4. A computer-readable storage medium of claim 1, wherein the action related to the content is performed in response to receiving the message generated by the script from another user.

5. A computer-readable storage medium of claim 1, wherein:
the request for the content locket for the user is received from a web server;
the one or more processors are caused to further perform initiating sending a locket event message to the web server; and
the locket event message indicates that the action related to rendering the content is performed.

6. A computer-readable storage medium of claim 1, wherein the one or more processors are caused to further perform periodically determining content that is currently being rendered in response to the user input.

7. A computer-readable storage medium of claim 1, wherein the content locket further includes data that indicates metadata for the content playlist associated with the user.

8. An apparatus comprising a processor and a memory storing executable instructions that if executed cause the apparatus to perform at least the following:
receive a request for a content locket for a user wherein the content locket includes
data indicating a content playlist associated with the user, and
script for generating a message that requests an action related to content indicated in the content playlist;
initiate sending the content locket; and
in response to receiving the message generated by the script, initiate performing the action related to the content.

9. An apparatus of claim 8, wherein the action related to the content includes one of starting a rendering, stopping the rendering, or pausing the rendering.

10. An apparatus of claim 8, wherein the action related to the content is to start rendering content that is currently being rendered by the user.

11. An apparatus of claim 8, wherein the action related to the content is performed in response to receiving the message generated by the script from another user.

12. An apparatus of claim 8, wherein:
the request for the content locket for the user is received from a web server;
the processor and the memory are further configured to initiate sending a locket event message to the web server; and
the locket event message indicates that the action related to the content is performed.

13. An apparatus of claim 8, wherein the processor and the memory are further configured to periodically determine content that is currently being rendered in response to input from the user.

14. An apparatus of claim 8, wherein the content locket further includes data that indicates metadata for the content playlist associated with the user.

15. A system including the apparatus of claim 8, the system further comprising a web server configured to send the request for the content locket for the user.

16. A method comprising:
providing access for sending a request for a content locket for a user, wherein the content locket includes
data indicating a content playlist associated with the user, and
script for generating a message that requests an action related to content indicated in the content playlist;
receiving the content locket; and
in response to sending the message generated by the script, causing the action related to the content to be performed.

17. A method of claim 16, wherein the action related to the content is performed in response to sending the message generated by the script from another user.

18. An apparatus comprising a processor and a memory storing executable instructions that if executed cause the apparatus to perform at least the following:
receive a first locket object to indicate content associated with a first user; and
in response to receiving the first locket object, embed the first locket object in a requested web page before initiating returning the requested web page to a web browser process for the first user.

19. An apparatus of claim 18, wherein the processor and the memory are further configured to:
determine a different second user based on the first locket object;
initiate requesting a second locket object to indicate content associated with the second user; and
in response to receiving the second locket object, embed the second locket object in the requested web page before initiating returning the requested web page to the web browser process for the first user.

20. An apparatus of claim 18, wherein the processor and the memory are further configured to:
receive a locket event message that indicates that an action related to the content is performed; and
in response to receiving the locket event message, initiate reporting the action to a reporting service.
